(19) United States
(12) Patent Application Publication
(10) Pub. No.: US 2014/0078624 A1
(43) Pub. Date: Mar. 20, 2014

(54) SEMICONDUCTOR INTEGRATED CIRCUIT WITH ESD PROTECTION CIRCUIT

(71) Applicant: KABUSHIKI KAISHA TOSHIBA, TOKYO (JP)

(72) Inventors: TETSU NAGAMATSU, KANAGAWA-KEN (JP); KATSUYA KUDO, OOITA-KEN (JP)

(73) Assignee: KABUSHIKI KAISHA TOSHIBA, TOKYO (JP)

(21) Appl. No.: 13/777,188

(22) Filed: Feb. 26, 2013

(30) Foreign Application Priority Data
Sep. 20, 2012 (JP) 2012-207564

(51) Int. Cl. H02H 9/04

(52) U.S. Cl. CPC H02H 9/04
USPC 361/18

(57) ABSTRACT

According to an embodiment, a semiconductor integrated circuit includes a first power supply terminal, a second power supply terminal, a regulator circuit, an electrostatic discharge (ESD) protection circuit, and a level shift circuit. A first voltage is applied to the first power supply terminal. A second voltage different from the first voltage is applied to the second power supply terminal. The regulator circuit adjusts the second voltage, and outputs the second voltage adjusted as an output voltage to an output terminal. The ESD protection circuit discharges ESD generated at the output terminal. The level shift circuit level-shifts the magnitude of the first voltage to the magnitude of the second voltage, and outputs a first control signal to electrically separate the regulator circuit from the ESD protection circuit depending on whether or not the first and second voltages are applied.

### CROSS REFERENCE TO RELATED APPLICATION

This application is based upon and claims the benefit of priority from the prior Japanese Patent Application No. 2012-207564, filed on Sep. 20, 2012, the entire contents of which are incorporated herein by reference.

### FIELD

Embodiments described herein relate to a semiconductor integrated circuit with an electrostatic discharge (ESD) protection circuit.

### BACKGROUND

A semiconductor integrated circuit includes an electrostatic discharge (ESD) protection circuit to prevent the semiconductor integrated circuit from destruction by the ESD.

When a power supply voltage is not applied to the semiconductor integrated circuit, the ESD protection circuit protects the semiconductor integrated circuit from the ESD. When a power supply voltage is applied to the semiconductor integrated circuit and the semiconductor integrated circuit is driven, the ESD protection circuit is not driven.

While the semiconductor integrated circuit is driven, when a leak current is supplied to the ESD protection circuit or a potential of a wiring to which the ESD protection circuit is connected rises, the ESD protection circuit may malfunction. The malfunction of the ESD protection circuit may cause a failure of the semiconductor integrated circuit.

### BRIEF DESCRIPTION OF THE DRAWINGS

FIG. 1 is a schematic block diagram showing a configuration of a semiconductor integrated circuit according to an embodiment;

FIG. 2 is a circuit diagram showing a configuration of a power supply circuit according to the embodiment;

FIG. 3 is a timing chart showing an operation of the power supply circuit according to the embodiment when the power supply circuit is not driven and electrostatic discharge (ESD) is applied; and

FIG. 4 is a timing chart showing an operation of the power supply circuit according to the embodiment when the power supply circuit is driven.

### DETAILED DESCRIPTION OF THE INVENTION

According to an embodiment, a semiconductor integrated circuit includes a first power supply terminal, a second power supply terminal, a regulator circuit, an electrostatic discharge (ESD) protection circuit, and a level shift circuit. A first voltage is applied to the first power supply terminal. A second voltage different from the first voltage is applied to the second power supply terminal. The regulator circuit adjusts the second voltage, and outputs the second voltage adjusted as an output voltage to an output terminal. The ESD protection circuit discharges ESD generated at the output terminal. The level shift circuit level-shifts the magnitude of the first voltage to the magnitude of the second voltage, and outputs a first control signal to electrically separate the regulator circuit from the ESD protection circuit depending on whether or not the first and second voltages are applied.

Further embodiments will be described below with reference to the drawings. In the drawings, the same reference symbols denote the same or similar portions.

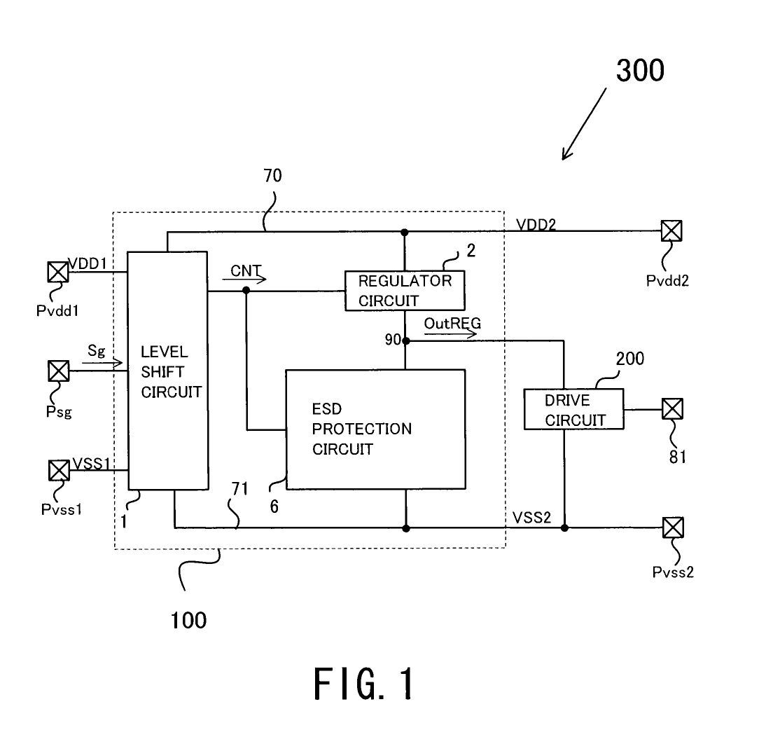

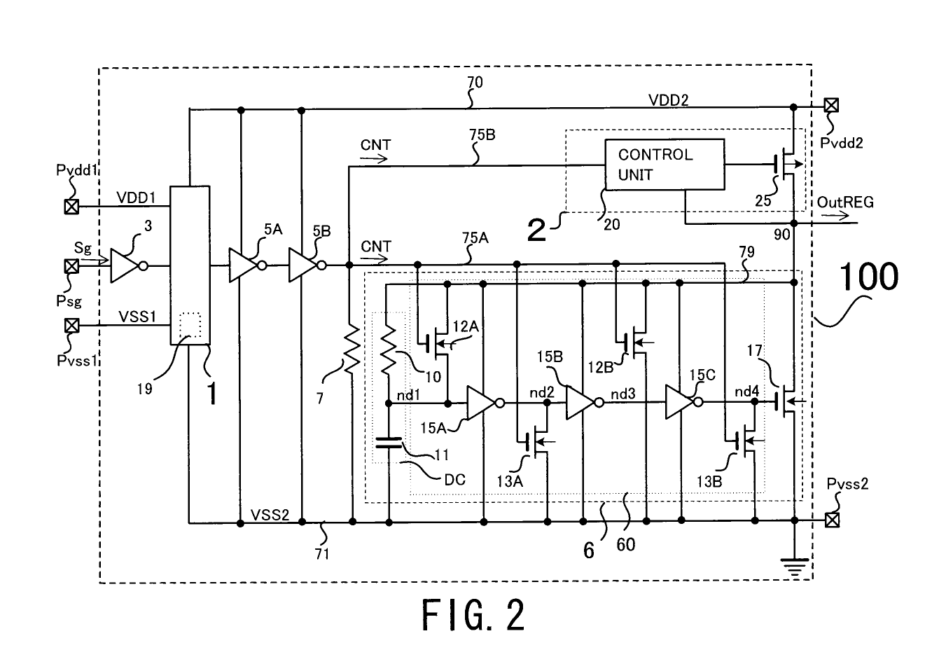

A semiconductor integrated circuit with an ESD protection circuit according to an embodiment will be described with reference to drawings. FIG. 1 is a schematic block diagram showing a configuration of the semiconductor integrated circuit. FIG. 2 is a circuit diagram showing a configuration of a power supply circuit.

As shown in FIG. 1, a semiconductor integrated circuit 300 includes a power supply circuit 100, a drive circuit 200, a power supply line 70, a ground line 71, a terminal 81, a terminal Pvdd1, a terminal Pvdd2, a terminal Pvss1, a terminal Pvss2, and a terminal Psg. The power supply circuit 100 includes a level shift circuit 1, a regulator circuit 2, an ESD protection circuit 6, the power supply line 70, and the ground line 71.

The semiconductor integrated circuit 300 has the terminal Pvdd1 (the first power supply terminal) and the terminal Pvss1 (the first ground terminal) connected to a first power supply system, and the terminal Pvdd2 (a second power supply terminal) and the terminal Pvss2 (a second ground terminal) connected to a second power supply system.

The first power supply system is configured of a power supply voltage VDD1 (the first voltage) supplied via the terminal Pvdd1, and a ground voltage VSS1. The second power supply system is configured of a power supply voltage VDD2 (the second voltage) supplied via the terminal Pvdd2, and a ground voltage VSS2. The power supply voltage VDD1 and the power supply voltage VDD2 are each also referred to as a driving voltage. The ground voltage VSS1 and the ground voltage VSS2 are each also referred to as a ground potential.

The power supply voltage VDD1 and the power supply voltage VDD2 have different voltage values. For example, the power supply voltage VDD1 is set to be lower than the power supply voltage VDD2. The ground voltage VSS1 and the ground voltage VSS2 are set to the same voltage magnitude (e.g., 0V), for example.

The level shift circuit 1 is connected to the first and second supply voltage systems. A signal Sg is input to the level shift circuit 1 via the terminal Psg. The level shift circuit 1 outputs a control signal CNT (the first control signal) via an inverter (not shown).

The level shift circuit 1 adjusts a voltage difference between a difference of voltage, which is between the power supply voltage VDD1 of the first power supply system and the ground voltage VSS1, and a difference of voltage, which is between the power supply voltage VDD2 of the second power supply system and the ground voltage VSS2. For example, the level shift circuit 1 level-shifts the power supply voltage VDD1 of the first power supply system, and outputs the power supply voltage VDD2 of the second power supply system. Alternatively, the level shift circuit 1 may level-shift the power supply voltage VDD2 of the second power supply system, and output the power supply voltage VDD1. When both the power supply voltage VDD1 and the power supply voltage VDD2 are applied to the power supply circuit 100, the level shift circuit 1 adjusts the difference between the power supply voltages depending on the specification of the circuits connected to the power supply circuit 100.

The power supply line 70 is connected to the level shift circuit 1 at one end, and is connected to the terminal Pvdd2 at the other end. The power supply voltage VDD2 of the second power supply system is applied to the power supply line 70 via the level shift circuit 1 or directly from the power supply terminal. The ground line 71 is connected to the ESD protection circuit 6 at one end, and is connected to the terminal Pvss2 at the other end. The ground voltage (also referred to as the ground potential) is applied to the ground line 71.

The regulator circuit 2 is connected to the level shift circuit 1 via the power supply line 70. The power supply voltage VDD2 is supplied to the regulator circuit 2 via the power supply line 70, and the control signal CNT is input to the regulator circuit 2. An output terminal 90 of the power supply circuit 100 is connected to an output side of the regulator circuit 2. The output terminal 90 is connected to the drive circuit 200. An output voltage OutREG at a “V_{REG}” level of the regulator circuit 2 output from the output terminal 90 is input to the drive circuit 200, and the ground voltage VSS2 is applied to the drive circuit 200. The drive circuit 200 outputs a signal driving the output voltage OutREG to the terminal 81.

The drive circuit 200 and the power supply circuit 100 are formed on the same chip, the drive circuit 200 and the power supply circuit 100 may be formed on different chips.

The regulator circuit 2 adjusts the magnitude of the power supply voltage VDD2 of the power supply line 70. An adjusted voltage at a “V_{REG}” level is output as the output voltage OutREG via the output terminal 90. As a result, the power supply circuit 100 supplies a uniform voltage/current output to the drive circuit 200 or other circuit(s) (not shown) connected to the power supply circuit 100.

The control signal CNT is input to the ESD protection circuit 6. The ESD protection circuit 6 is connected to the ground line 71 and is connected to the regulator circuit 2 via the output terminal 90.

The ESD protection circuit 6 prevents the level shift circuit 1, the regulator circuit 2 and the drive circuit 200 (including other circuit(s) connected to the power supply circuit 100 via the output terminal 90) from being damaged by the ESD generated at the output terminal 90.

The ESD protection circuit 6 includes, for example, a capacitor as a circuit configuration element. As a more specific example, the ESD protection circuit 6 includes a delay circuit configured of a resistive element and a capacitor. The ESD protection circuit including the delay circuit is also referred to as a delay circuit type ESD protection circuit.

According to the embodiment, the regulator circuit 2 is set to an active state (an operating state) and the ESD protection circuit 6 is set to an inactive state based on the control signal CNT output from the level shift circuit 1 when the power supply circuit 100 to which the power supply voltage VDD1, the ground voltage VSS1, the power supply voltage VDD2, and the ground voltage VSS2 are supplied is driven.

As a result, when the power supply voltage VDD1, the power supply voltage VDD2, the ground voltage VSS1, and the ground voltage VSS2 are applied to the power supply circuit 100, the ESD protection circuit 6 is electrically separated from the regulator circuit 2. Accordingly, it is possible to prevent the voltage/current output from the regulator circuit 2 from leaking into the ESD protection circuit 6 and a large flow through current (rush current) within the power supply circuit 100 from being generated when the power supply circuit 100 is driven.

Referring to FIG. 2, a specific circuit configuration of the power supply circuit 100 will be described.

As shown in FIG. 2, the power supply circuit 100 includes the level shift circuit 1, the regulator circuit 2, an inverter 3, an inverter 5A, an inverter 5B, the ESD protection circuit 6, the resistive element 7, the power supply line 70, the ground line 71, a control signal line 75A, and a control signal line 75B.

The regulator circuit 2 includes a control unit 20 and a transistor 25 (a second transistor). The regulator circuit 2 adjusts the output of the power supply circuit 100.

The control signal line 75B where the control signal CNT is transmitted is connected to an input side of the control unit 20. The control unit 20 controls operation of the transistor 25 based on the control signal CNT.

A control terminal (a gate) of the transistor 25 is connected to an output side of the control unit 20. The power supply voltage VDD2 is applied to one end (a source) of the transistor 25, and the other end (a drain) of the transistor 25 is connected to the output terminal 90. The transistor 25 outputs the output voltage OutREG from the other end (the output terminal 90).

The transistor 25 is a P-channel metal oxide semiconductor field effect transistor (MOSFET) having a relatively high breakdown voltage. The transistor having a relatively high breakdown voltage is a transistor including a gate insulation film having a high dielectric breakdown voltage and having a high breakdown voltage between a source and a drain. The transistor 25 is also referred to as a regulator transistor.

The control unit 20 monitors a potential at the other end of the transistor 25, and adjusts a voltage applied to the control terminal of the transistor 25. As a result, a drive force and an output of the transistor 25 are controlled. The control unit 20 controls the output voltage OutREG and the output current of the transistor 25 so that a predetermined voltage/current is output from the power supply circuit 100.

Based on the control of the regulator circuit 2, the power supply circuit 100 to which the power supply voltage VDD1 and the power supply voltage VDD2 are supplied can output the predetermined voltage/current.

When the power supply voltage VDD2 is, for example, 2.8 V, the regulator circuit 2 adjusts the output of the power supply circuit 100 so that the output voltage OutREG becomes about 1.2 V.

The other end of the transistor 25 may be connected to the control terminal. In this case, the transistor 25 becomes a diode-connected transistor.

The ESD protection circuit 6 includes a transistor 17 (a first transistor), a control circuit 60, and a delay circuit DC.

The delay circuit DC delays an ESD pulse (voltage/current) generated due to the ESD and outputs the pulse delayed to the control circuit 60 when the ESD is generated at the output terminal 90 of the power supply circuit 100.

The delay circuit DC includes a resistive element 10 and a capacitor 11. One end of the resistive element 10 is connected to the output terminal 90, and the other end of the resistive element 10 is connected to a node nd1. One end of the capacitor 11 is connected to the node nd1, and the other end of the capacitor 11 is connected to the ground line 71 to which the ground voltage VSS2 is applied. The node nd1 becomes an output node of the delay circuit DC.

When the power supply voltage VDD1, the ground voltage VSS1, the power supply voltage VDD2, and the ground voltage VSS2 are supplied, the control circuit 60 makes the ESD protection circuit 6 be in an inactive state (off state) based on the control signal CNT.

The control circuit 60 includes an inverter 15A (a first inverter), an inverter 15B (a second inverter), an inverter 15C (a third inverter), a control switch 12A (a first switch), a control switch 13A (a second switch), a control switch 12B (a third switch), and a control switch 13B (a fourth switch).

The inverter 15A, the inverter 15B, and the inverter 15C are connected in series between the node nd1 (an output node of the delay circuit DC) and a control terminal of the transistor 17.

The inverter 15A is connected to the node nd1 (the output node of the delay circuit DC) at an input side, is connected to a node nd2 at an output side, and inverts the signal of the node nd1. The inverter 15B is connected to the node nd2 at an input side, is connected to a node nd3 at an output side, and inverts the signal of the node nd2. The inverter 15C is connected to the node nd3 at an input side, is connected to a node nd4 (the control terminal (gate) of the transistor 17) at an output side, and inverts the signal of the node nd3.

Based on the inverter 15A, the inverter 15B, and the inverter 15C connected in series, operation of the transistor 17 is controlled.

A control terminal of the of the capacitor 11 is connected to the control signal line 75A where the control signal CNT is transmitted, one end of the of the capacitor 11 is connected to a control line 79 (the output terminal 90), and the other end of the of the capacitor 11 is connected to the node nd1 (the input side of the inverter 15A). A control terminal of the control switch 13A is connected to the control signal line 75A, one end of the control switch 13A is connected to the node nd2 (the output side of the inverter 15A), and the other end of the control switch 13A is connected to the ground line 71 to which the ground voltage VSS2 is applied. A control terminal of the control switch 12B is connected to the control signal line 75A, one end of the control switch 12B is connected to a control line 79 (the output terminal 90), and the other end of the control switch 12B is connected to the node nd3 (the output side of the inverter 15B). A control terminal of the control switch 13B is connected to the control signal line 75A, one end of the control switch 13B is connected to the node nd4 (the output side of the inverter 15C and the control terminal of the transistor 17), and the other end of the control switch 13B is connected to the ground line 71.

The control switch 12A, the control switch 13A, the control switch 12B, and the control switch 13B are each, for example, an N-channel MOSFET having a relatively low breakdown voltage.

The control switch 12A, the control switch 13A, the control switch 12B, and the control switch 13B each operate depending on the signal level of the control signal CNT when the control signal CNT is input to the control terminal.

The inverter 15A, the inverter 15B, and the inverter 15C are configured by N-channel MOSFETs and P-channel MOSFETs each having a relatively low breakdown voltage, for example. The transistor having the relatively low breakdown voltage has a thinner gate insulation film and a lower breakdown voltage between a source and a drain as compared with the transistor having a high breakdown voltage. The control circuit 60 is also referred to as an off control circuit.

The transistor 17 is connected to the node nd4 (the output side of the inverter 15C) at the control terminal, connected to the output terminal 90 at one end, and connected to the ground line 71 at the other end. The transistor 17 is also referred to as a discharge transistor. The transistor 17 is the N-channel MOSFET having a relatively high breakdown voltage, for example. The N-channel MOSFET having a relatively high breakdown voltage is a transistor including a gate insulation film having a dielectric high breakdown voltage and having a high breakdown voltage between a source and a drain.

When the N-channel MOSFET is used for the transistor 17, odd-numbered inverters are preferably formed in series within the control circuit 60. In the embodiment, three inverters (the inverter 15A, the inverter 15B, and the inverter 15C) connected in series are formed, but the number of inverters is not necessarily limited to three. The number of inverters within the control circuit 60 may be one or five or more so long as the number is odd. For example, when one inverter is used, only the control switch 12A and the control switch 13A needs to be formed.

When the ESD is applied to the terminal 81 or the output terminal 90, an ESD pulse (ESD voltage V_{ESD}/ESD current) generated raises a potential of the control line 79 that connects the output terminal 90 with the control circuit 60 of the ESD protection circuit 6. The rise in the potential of the control line 79 triggers the ESD protection circuit 6, thereby driving the control circuit 60. As a result, the control circuit 60 makes the transistor 17 be in an on-state.

The ESD generated at the output terminal 90 is discharged to the ground by the transistor 17 in the on-state. As a result, the power supply circuit 100 and other circuit(s) connected to the power supply circuit 100 are protected from the ESD.

It is preferable that the ESD protection circuit 6 be designed so that the ESD protection circuit 6 becomes off directly before the output of the regulator circuit 2 rises by controlling a drive force of the inverter(s) within the control circuit 60 and optimally selecting the number of the inverters.

The ESD has a positive or negative polarity. A diode that is connected in parallel with the ESD protection circuit 6 is preferably disposed, for example, between the output terminal 90 and the ground line 71 in order to discharge the ESD having the negative polarity. In this case, a cathode of the diode is connected to the output terminal 90, and an anode of the diode is connected to the ground line 71. The ESD having the negative polarity is discharged to the ground line 71 via the diode.

The inverter 3 is driven by supplying the power supply voltage VDD1 and the ground voltage VSS1 of the first power supply system. A signal Sg (for example, a logic signal) is input to the inverter 3 via the terminal Psg. The inverter 3 inverts the signal Sg.

The power supply voltage VDD1 and the ground voltage VSS1 of the first power supply system and the power supply voltage VDD2 and the ground voltage VSS2 of the second power supply system are supplied to the level shift circuit 1. An inverted signal of the signal Sg is input to the level shift circuit 1. The level shift circuit 1 raises or drops the power supply voltage VDD1 and the ground voltage VSS1 so that the power supply voltage VDD1 and the ground voltage VSS1 have the same level as that of the power supply voltage VDD2 and the ground voltage VSS2 of the second power supply system.

The level shift circuit 1 detects at least one of the application of the power supply voltage VDD1, the ground voltage VSS1, the power supply voltage VDD2, and the ground voltage VSS2 and an input of the inverted signal of the signal Sg. The level shift circuit 1 generates the control signal CNT from a detected result, and outputs the control signal CNT to the regulator circuit 2 and the ESD protection circuit 6. The regulator circuit 2 is set to an active state and the ESD protection circuit 6 is set to an inactive state based on the control signal CNT when the power supply voltage VDD1, the ground voltage VSS1, the power supply voltage VDD2, and the ground voltage VSS2 are applied. As a result, when the regulator circuit 2 starts to output the output voltage OutREG, the ESD protection circuit 6 can be substantially electrically separated from the output node (output terminal 90) of the regulator 2.

The level shift circuit 1 includes a control signal generation unit 19. The control signal generation unit 19 generates the control signal to control the operation of the regulator circuit 2 and the ESD protection circuit 6 based on the detected result of the application of the power supply voltage VDD1, the ground voltage VSS1, the power supply voltage VDD2, and the ground voltage VSS2 or the input of the inverted signal input of the signal Sg.

The power supply voltage VDD2 and the ground voltage VSS2 are supplied to the inverter 5A. The inverter 5A inverts the control signal output from the level shift circuit 1. The power supply voltage VDD2 and the ground voltage VSS2 are supplied to the inverter 5B. The inverter 5B inverts the control signal output from the inverter 5A, outputs the control signal CNT (the first control signal) to the ESD protection circuit 6 via the control signal line 75A, and outputs the control signal CNT (the first control signal) to the regulator circuit 2 via the control signal line 75B.

When the power supply voltage VDD1 and the power supply voltage VDD2 are not applied to the power supply circuit 100, the control signal CNT is set to an “L” level. When the power supply voltage VDD1 and the power supply voltage VDD2 are applied to the power supply circuit 100, the control signal CNT is set to a “VDD2” level.

For example, the inverter 3 is configured of an N-channel MOSFET and a P-channel MOSFET each having a relatively low breakdown voltage. The inverter 5A and the inverter 5B are configured of an N-channel MOSFET and a P-channel MOSFET each having a relatively higher breakdown voltage than those of the inverter 3.

The resistive element 7 is connected to the control signal line 75A and the control signal line 75B at one end and connected to the ground line 71 at the other end. The resistive element 7 is a resistive element to stabilize the operation of the power supply circuit 100. The resistive element 7 functions to prevent the level shift circuit 1 or the ESD protection circuit 6 from being a floating state when the potentials of the control signal line 75A and the control signal line 75B rise.

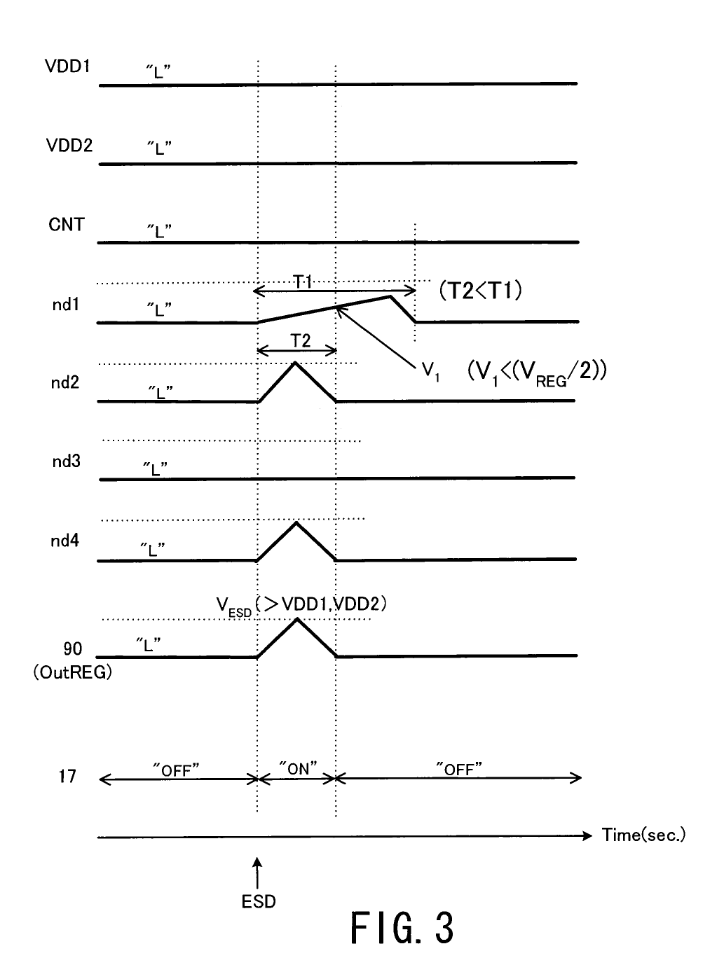

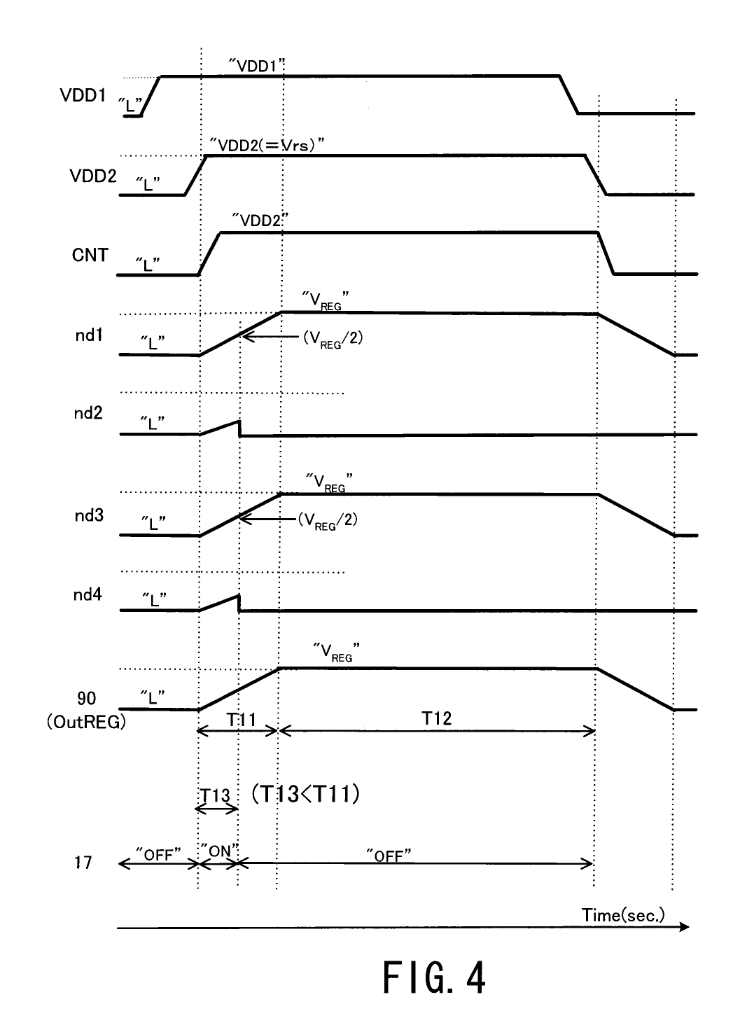

An operation of the semiconductor integrated circuit 300 according to the embodiment will be described with reference to drawings. FIG. 3 is a timing chart showing an operation of the power supply circuit when the power supply circuit is not driven and the ESD is applied. FIG. 4 is a timing chart showing an operation of the power supply circuit when the power supply circuit is driven. The operation of the power supply circuit 100 according to the embodiment will be described with reference to FIGS. 1 and 2 as well as FIGS. 3 and 4. FIG. 3 is the timing chart showing the operation of the power supply circuit when the ESD having the positive charge is generated.

As shown in FIG. 3, when the power supply voltage VDD1 and the power supply voltage VDD2 are not supplied to the power supply circuit 100, the power supply voltage VDD1 and the power supply voltage VDD2 are set to the “L” level. The signal Sg is not supplied to the power supply circuit 100. The power supply circuit 100 is not driven.

As the power supply circuit 100 is not driven, a signal level of the control signal CNT becomes the “L” level. The potentials of the control signal line 75A and the control signal line 75B are set to the “L” level.

The signal CNT at the “L” level is input to the regulator circuit 2 and the control circuit 60 of the ESD protection circuit 6.

When the control signal CNT is at the “L” level, the regulator circuit 2 is set to an inactive state, and the transistor 25 is off by the control of the control unit 20.

In a case that the ESD having the positive charge is applied, for example, to the terminal 81 when the power supply circuit 100 and the drive circuit 200 are not operated, the potential of the output terminal 90 rises due to the ESD pulse applied via the terminal 81 and the drive circuit 200.

As shown in FIG. 3, when the ESD is generated, the ESD voltage V_{ESD} that is a voltage due to the ESD pulse is applied to the output terminal 90. As a result, the ESD current corresponding to the ESD voltage V_{ESD} is generated. For example, the ESD applied to the terminal 81 is within the range of tens V to several kV, which is greater than the power supply voltage VDD1 and the power supply voltage VDD2 used in the power supply circuit 100. Accordingly, the ESD voltage V_{ESD} becomes greater than the power supply voltage VDD1 and the power supply voltage VDD2. When the ESD having the positive charge is directly applied to the output terminal 90, the ESD voltage V_{ESD} becomes greater as compared with the case that the ESD having the positive charge is applied to the terminal 81.

When a pulse-like ESD voltage V_{ESD} is applied to the output terminal 90, the pulse-like ESD voltage V_{ESD} is supplied to the inverter 15A, the inverter 15B, the inverter 15C within the control circuit 60, and the delay circuit DC via the control line 79. As a result, the inverter 15A, the inverter 15B, and the inverter 15C start to operate. The delay circuit DC outputs a signal to delay the pulse-like ESD voltage V_{ESD} from the node nd1. Specifically, the delay circuit DC outputs from the node nd1 a pulse-like voltage for a time T1 longer than a time T2 of the pulse-like ESD voltage V_{ESD}. As a result, the voltage V1 at the node nd1 does not reach a circuit threshold (for example, the “V_{REG}” level/2) of the inverter 15A, the inverter 15B, and the inverter 15C even immediately after the time T2 is ended.

As the control signal CNT is set to the “L” level, the control switch 12A, the control switch 12B, the control switch 13A, and the control switch 13B are off before the ESD is applied, while the ESD is applied, and after the ESD is discharged. Therefore, a current does not flow between the node nd3 and the control line 79. Also, a current does not flow between the node nd2 and the ground line 71 and between the node nd4 and the ground line 71. Before the ESD voltage V_{ESD} is applied to the output terminal 90, the node nd1, the node nd2, the node nd3, the node nd4, and the output terminal 90 are set to, for example, the “L” level.

When the pulse-like ESD voltage V_{ESD} is applied, the signal of the node nd1 input to the inverter 15A becomes the “L” level (the circuit threshold or less), the signal of the node nd2 output from the inverter 15A becomes an “H” level, the signal of the node nd3 output from the inverter 15B becomes the “L” level, and the signal of the node nd4 output from the inverter 15C becomes the “H” level during the ESD pulse time T1.

When the signal of the node nd4 at the “H” level is input to the control terminal of the transistor 17, the transistor 17 is turned on at almost the same time of the generation of the ESD depending on the signal level of the node nd4, and turned off at almost the same time of the ending of the ESD pulse, i.e., immediately after the time T2. As a result, the transistor 17 flows the ESD current from one end (at the output terminal 90 side) to the other end (at the ground line 71 side) during the time T1. Accordingly, after the ESD applied to the terminal 81, and the pulse-like ESD generated at the output terminal 90 is discharged rapidly by the transistor 17 of the control circuit 60.

As described above, when the power supply voltage VDD1 and the power supply voltage VDD2 are not supplied, the power supply circuit 100 and other circuit(s) (not shown) connected to the power supply circuit 100 are protected by the operation of the ESD protection circuit as shown in FIG. 3 from the ESD generated.

Next, the operation of the power supply circuit 100, where the power supply voltage is applied to the power supply circuit 100 and the other circuit(s) (not shown) connected to the power supply circuit 100 and each circuit is operated normally (performs a predetermined function), will be described with reference to FIG. 4.

As shown in FIG. 4, when the power supply voltage VDD1 and the power supply voltage VDD2 are supplied to the power supply circuit 100, the power supply voltage VDD1 becomes a “VDD1” level from the “L” level. The level shift circuit 1 adjusts the power supply voltage VDD1 and outputs the power supply voltage VDD2 at a “VDD2” level. For example, the level shift circuit 1 outputs a voltage Vrs obtained by level-shifting the power supply voltage VDD1 as the power supply voltage VDD2 to the power supply line 70.

While the power supply voltage VDD1 and the ground voltage VSS1 are supplied, the signal Sg (a logic signal) is input to the inverter 3 via the terminal Psg from an outside of the semiconductor integrated circuit 300. The inverted signal of the signal Sg is input to the level shift circuit 1 from the inverter 3.

The control signal generation unit 19 of the level shift circuit 1 detects the application of the power supply voltage VDD1, the ground voltage VSS1, the power supply voltage VDD2, and the ground voltage VSS2 or the input of the signal Sg, and generates the control signal at the “VDD2” level that is the detected result. The control signal at the “VDD2” level is transmitted to the control signal line 75A and the control signal line 75B as the control signal CNT via the inverter 5A and the inverter 5B that are connected in series.

The control signal CNT at the “VDD2” level is input to the control unit 20 of the regulator circuit 2 via the control signal line 75B. The control unit 20 turns the transistor 25 on based on the control signal CNT at the “VDD2” level. As a result, the voltage (the output voltage OutREG) of the output terminal 90 (at the other end of the transistor 25) rises from the “L” level to the “V_{REG}” level.

The voltage (the output voltage OutREG) of the output terminal 90 is supplied to the inverter 15A, the inverter 15B, and the inverter 15C via the control line 79, the inverters start to operate. The circuit threshold of the inverter 15A, the inverter 15B, and the inverter 15C is set to (“V_{REG}” level/2). As the control signal CNT is applied to the control terminal, the control switch 12A, the control switch 12B, the control switch 13A, and the control switch 13B start to operate.

The control switch 12A is turned on substantially during the time T11 as the control signal CNT is applied to the control terminal of the control switch 12A, the output voltage OutREG is applied to the one end of the control switch 12A, and the output voltage OutREG is applied to the other end of the control switch 12A via the resistive element 7. After the time T11, the one end and the other end of the control switch 12A have the same potential. Then, the control switch 12A is turned off. As a result, the node nd1 and the output terminal 90 have substantially the same waveform.

The inverter 15A outputs the signal at the “H” level to the node nd2 during a time T13 when the signal level of the input (the node ndl) is the “L level” that is less than the circuit threshold voltage (“V_{REG}” level/2). The inverter 15A outputs the signal at the “L” level to the node nd2 after the time T13 is ended when the signal level of the input (the node nd1) is the “H level” that is not less than the circuit threshold voltage (“V_{REG}” level/2). On the other hand, the control switch 13A is turned on and operates to change the voltage of the node nd2 to the “L” level (the ground voltage VSS) when the control signal CNT is applied to the control terminal and a potential difference is generated between the one end and the other end. As a result, the voltage of the node nd2 rises from the “L” level to a relatively low voltage during the time T13, and is set to the “L” level after the time T13 is ended.

During the time T11, the signal at the “L” level that is less than the circuit threshold voltage (“V_{REG}” level/2) is input to the inverter 15B, and the signal at the “H” level is output from the inverter 15B to the node nd3. After the time T11 is ended, the signal at the “L” level is input to the inverter 15B, and the signal at the “H” level is output from the inverter 15B to the node nd3. On the other hand, the control switch 12B is turned on substantially during the time T11 as the control signal CNT is applied to the control terminal of the control switch 12B, the output voltage OutREG is applied at the one end of the control switch 12B, and the voltage of the node nd3 is applied at the other end of the control switch 12B. After the time T11, the one end and the other end of the control switch 12B have the same potential. Then, the control switch 12B is turned off. As a result, the node nd3 and the output terminal 90 have substantially the same waveform.

The inverter 15C outputs the signal at the “H” level to the node nd4 during the time T13 when the signal level of the input (the node nd3) is the “L level” that is less than the circuit threshold voltage (“V_{REG}” level/2). The inverter 15C outputs the signal at the “L” level to the node nd2 after the time T13 is ended when the signal level of the input (the node nd3) is the “H level” that is not less than the circuit threshold voltage (“V_{REG}” level/2). On the other hand, the control switch 13B is turned on and operates to change the voltage of the node nd4 to the “L” level (the ground voltage VSS) when the control signal CNT is applied to the control terminal of the control switch 13B and a potential difference is generated between the one end and the other end of the control switch 13B. As a result, the voltage of the node nd4 rises from the “L” level to a relatively low voltage during the time T13, and is set to the “L” level after the time T13 is ended.

Therefore, the transistor 17 is turned off before the time T13. During the time T13, the transistor 17 is turned on. However, as the voltage applied to the control terminal of the transistor 17 is relatively low, it is possible significantly suppress a current flowing from one end (the output terminal 90 side) to the other end (the ground line 71 side) of the transistor 17.

After the transistor 17 is turned on to off and the predetermined time T11 elapses, the output voltage OutREG at the “V_{REG}” level is output from the output terminal 90. During the time T12 when the output voltage OutREG at the “V_{REG}” level is output from the output terminal 90, the transistor 17 maintains off, and the ESD protection circuit 6 is substantially electrically separated from the output terminal 90. Accordingly, it is possible to prevent significantly the output voltage OutREG of the regulator circuit 2 from leaking into the ESD protection circuit 6.

After the time T12, when the supply of the power supply voltage VDD1 and the power supply voltage VDD2 are stopped and the power supply circuit 100 is turned off, the control signal CNT is changed from the “VDD2” level to the “L” level. The regulator circuit 2 is set to the inactive state, the potential of the output voltage OutReg drops, and the output voltage OutReg is set to the “L” level. As a result, the power supply circuit 100 stops the operation.

As described above, the level shift circuit 1 outputs the control signal CNT to control the active/inactive state of the regulator circuit 2 and the ESD protection circuit 6 in the power supply circuit 100 according to the embodiment.

When the power supply voltage VDD1 and the power supply voltage VDD2 are not supplied, the ESD generated at the output terminal 90 can be discharged rapidly to the ground. When the power supply voltage VDD1 and the power supply voltage VDD2 are supplied and the power supply circuit 100 is activated, the ESD protection circuit 6 is set to the inactive state and is electrically separated from the regulator circuit 2 (the output terminal 90 of the power supply circuit 100) based on the control signal CNT from the level shift circuit 1.

Therefore, the power supply circuit 100 according to the embodiment can prevent significantly the leak current (the rush current) from flowing to the ESD protection circuit 6 when the power supply voltage VDD1 and the power supply voltage VDD2 are supplied, prevent the failure of the regulator circuit 2 due to the leak current, and activate the power supply circuit 100 stably.

Accordingly, the semiconductor integrated circuit 300 according to the embodiment can prevent the failure due to the malfunction of the ESD protection circuit 6.

In addition, in the semiconductor integrated circuit 300 according to the embodiment, the ESD protection circuit 6 is formed within the power supply circuit 100, but is not necessarily limited to be formed within the power supply circuit 100. It may be sufficient that the ESD protection circuit 6 can be electrically separated from the regulator circuit 2.

The semiconductor integrated circuit 300 according to the embodiment can be used for a logic circuit, an image sensor, a flash memory, and a system LSI including the logic circuit, the image sensor, and the flash memory, for example.

The semiconductor integrated circuit 300 according to the embodiment is connected to a signal processing circuit (digital signal processor (DSP)) to process a signal from any of a complementary metal oxide semiconductor (CMOS) image sensor, a charge-coupled device (CCD) sensor, and an image sensor.

A sensor unit (a pixel array) and an AD converter circuit of the image sensor is configured by, for example, a transistor having a relatively high breakdown voltage. The logic circuit such as the DSP is configured by, for example, a transistor having a relatively low breakdown voltage.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor integrated circuit, comprising:
a first power supply terminal to which a first voltage is applied;
a second power supply terminal to which a second voltage different from the first voltage is applied;
a regulator circuit to adjust the second voltage and output the second voltage adjusted as an output voltage to an output terminal;
an electrostatic discharge (ESD) protection circuit to discharge ESD generated at the output terminal; and
a level shift circuit to level-shift the magnitude of the first voltage to the magnitude of the second voltage and output a first control signal to electrically separate the regulator circuit from the ESD protection circuit depending on whether or not the first and second voltages are applied.

2. The semiconductor integrated circuit according to claim 1, wherein
the ESD protection circuit includes:
a delay circuit having a resistive element and a capacitor;
a first transistor connected to the output terminal at one end and connected to a ground terminal to which a ground voltage is applied at the other end; and
a control circuit formed between a connection point, which is between the resistive element and the capacitor, and a control terminal of the first transistor, and wherein
the control circuit controls an operation of the first transistor based on the first control signal.

3. The semiconductor integrated circuit according to claim 2, wherein the first transistor is an N-channel metal oxide semiconductor field effect transistor (MOSFET).

4. The semiconductor integrated circuit according to claim 2, wherein
the control circuit includes:
a first inverter connected to a connection point between the resistive element and the capacitor at an input side and connected to a control terminal of the first transistor at an output side;
a first control switch having a control terminal connected to a first control line where the first control signal is supplied, one end connected to one end of the first transistor, and the other end connected to the input side of the first inverter; and
a second control switch having a control terminal connected to the first control line, one end connected to the output side of the first inverter, and the other end connected to the ground terminal,
when the first and second voltages are not applied and ESD is generated at the output terminal, the first invertor outputs an output signal to turn on the first transistor to the first transistor based on an input signal supplied from the delay circuit to the first inverter, and
when the first and second voltages are applied and the output voltage is output from the output terminal, the first and second control switches are turned on based on the first control signal, and the first inverter outputs a signal to turn off the first transistor to the first transistor based on an input signal supplied from the first control switch in an on-state to the first inverter.

5. The semiconductor integrated circuit according to claim 4, wherein the first and second control switches are each an N-channel MOSFET.

6. The semiconductor integrated circuit according to claim 2, wherein
the control circuit includes:
a first inverter connected to a connection point between the resistive element and the capacitor at an input side;
a second inverter connected to an output side of the first inverter at an input side;
a third inverter connected to an output side of the second inverter at an input side, and connected to the control terminal of the first transistor at an output side;
a first control switch having a control terminal connected to a first control line where the first control signal is supplied, one end connected to the one end of the first transistor, and the other end connected to an input side of the first inverter;
a second control switch having a control terminal connected to the first control line, one end connected to the output side of the first inverter, and the other end connected to the ground terminal;
a third control switch having a control terminal connected to the first control line, one end connected to the one end of the first transistor, and the other end connected to the output side of the second inverter; and
a fourth control switch having a control terminal connected to the first control line, one end connected to the output side of the third inverter, and the other end connected to the ground terminal,
when the first and second voltages are not applied and ESD is generated at the output terminal, the third invertor outputs an output signal to turn on the first transistor to the first transistor based on an input signal supplied from the delay circuit to the first inverter, and
when the first and second voltages are applied and the output voltage is output from the output terminal, the first through fourth control switches are turned on based on the first control signal, and the third inverter outputs a signal to turn off the first transistor to the first transistor based on an input signal supplied from the third control switch in an on-state to the third inverter.

7. The semiconductor integrated circuit according to claim 6, wherein the first through fourth control switches are each an N-channel MOSFET.

8. The semiconductor integrated circuit according to claim 1, wherein
the regulator circuit includes:
a first control unit to which the first control signal is input; and
a second transistor having a control terminal connected to an output side of the first control unit, one end connected to the second power supply terminal, and the other end connected to the output terminal, and wherein
the first control unit controls an operation of the second transistor based on the first control signal.

9. The semiconductor integrated circuit according to claim 8, wherein the second transistor is a P-channel MOSFET.

10. The semiconductor integrated circuit according to claim 1, wherein the level shift circuit includes a control signal generation unit to generate the first control signal based on a detected result of the application of the first and second voltages and a detected result of an input of a first signal input via a first terminal.

11. A semiconductor integrated circuit, comprising:
a first power supply terminal to which a first voltage is applied;
a second power supply terminal to which a second voltage different from the first voltage is applied;
a regulator circuit to adjust the second voltage and output the second voltage adjusted as an output voltage to an output terminal;
an electrostatic discharge (ESD) protection circuit to discharge ESD generated at the output terminal; and
a level shift circuit to level-shift the magnitude of the first voltage to the magnitude of the second voltage and output a first control signal to electrically separate the regulator circuit from the ESD protection circuit depending on whether or not the first and second voltages are applied,
the ESD protection circuit including:
a delay circuit having a resistive element and a capacitor;
a first transistor connected to the output terminal at one end and connected to a ground terminal to which a ground voltage is applied at the other end; and
a control circuit formed between a connection point, which is between the resistive element and the capacitor, and a control terminal of the first transistor, and
the control circuit including:
a first inverter connected to a connection point between the resistive element and the capacitor at an input side and connected to a control terminal of the first transistor at an output side;
a first control switch having a control terminal connected to a first control line where the first control signal is supplied, one end connected to the one end of the first transistor, and the other end connected to the input side of the first inverter; and
a second control switch having a control terminal connected to the first control line, one end connected to the output side of the first inverter, and the other end connected to the ground terminal,
when the first and second voltages are not applied and ESD is generated at the output terminal, the first invertor outputs an output signal to turn on the first transistor to the first transistor based on an input signal supplied from the delay circuit to the first inverter,
when the first and second voltages are applied and the output voltage is output from the output terminal, the first and second control switches are turned on based on the first control signal, and the first inverter outputs a signal to turn off the first transistor to the first transistor based on an input signal supplied from the first control switch in an on-state to the first inverter,
the regulator circuit including:
a first control unit to which the first control signal is input: and
a second transistor including a control terminal connected to an output side of the first control unit, one end connected to the second power supply terminal, and the other end connected to the output terminal, and
the first control unit controls an operation of the second transistor based on the first control signal.

12. The semiconductor integrated circuit according to claim 11, wherein the first transistor is an N-channel MOSFET.

13. The semiconductor integrated circuit according to claim 11, wherein the second transistor is a P-channel MOSFET.

14. The semiconductor integrated circuit according to claim 11, wherein the first and second control switches are each an N-channel MOSFET.

15. The semiconductor integrated circuit according to claim 11, wherein the level shift circuit includes a control signal generation unit to generate the first control signal based on a detected result of the application of the first and second voltages and a detected result of an input of a first signal input via a first terminal.
